(19) United States
(12) Patent Application Publication
(10) Pub. No.: US 2018/0314564 A1
(43) Pub. Date: Nov. 1, 2018

(54) COMMUNICATION IN A FEDERATED COMPUTING ENVIRONMENT

(71) Applicants: Sampath Kumar Chilukuri, Bangalore (IN); Ravi Kumar Gullapalli, Bangalore (IN); Srikanth Chakravarthula, Bangalore (IN); Balaji Radhakrishnan, Bangalore (IN); Asha Sadasivan, Bangalore (IN)

(72) Inventors: Sampath Kumar Chilukuri, Bangalore (IN); Ravi Kumar Gullapalli, Bangalore (IN); Srikanth Chakravarthula, Bangalore (IN); Balaji Radhakrishnan, Bangalore (IN); Asha Sadasivan, Bangalore (IN)

(21) Appl. No.: 15/573,882

(22) PCT Filed: May 27, 2015
(86) PCT No.: PCT/US2015/032547

§ 371 Date: Nov. 14, 2017

(51) Int. Cl. G06F 9/50; H04L 9/32; G06F 21/33; H04L 29/06

(52) U.S. Cl. CPC G06F 9/5077; G06F 9/5005; H04L 9/3234; G06F 21/335; G06F 2209/5011; H04L 63/0815; H04L 9/3213; H04L 63/0823; H04L 63/102

(57) ABSTRACT

Example implementations relate to communication in a federated computing environment. For example, a method includes identifying, by a computing resource, at least one other computing resource within the federated computing environment, where the federated computing environment includes a pool of computing resources. The method also includes exchanging trust parameters with each of the at least one other computing resource, where the trust parameters are indicative of identification and authenticity of computing resources within the pool of computing resources. The method also includes communicating a first set of tokens to each of the at least one other computing resource, and receiving a second set of tokens from the at least one other computing resource, such that the first set of tokens and the second set of tokens form a global set of tokens for accessing the pool of computing resources of the federated computing environment.

### BACKGROUND

In the rapidly evolving competitive marketplace, data processing is amongst an organization's most pressing requisite. Meeting day-to-day business requisites of organizations depends on availability of processing computing resources, the ability to quickly and seamlessly process data without considerable delay, and capability of transferring it quickly to the members of the organization. Organizations may extract, refine, manipulate, transform, integrate, and distribute data from one or more computing resources for effective functioning and seamless working.

In federated computing environments, multiple computing resources are utilized by organizations to process and store data in a distributed manner. Different computing resources within a federated computing environment may include different processing capabilities and may operate on different environments, such that data being processed by different computing resources are in different formats and used in varied contexts.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates an example federated computing environment, implementing a pool of computing resources, according to an example implementation of the present subject matter;

FIG. 2 illustrates elements of a computing resource, according to an example implementation of the present subject matter;

FIG. 3 illustrates various other elements of the computing resource, according to an example implementation of the present subject matter;

FIG. 4 is a flowchart representative of an example method of enabling communication in the federated computing environment, according to an example implementation of the present subject matter;

FIG. 5 is a flowchart representative of another example method of enabling communication in the federated computing environment, according to an example implementation of the present subject matter; and

FIG. 6 illustrates an example federated computing environment, implementing a non-transitory computer-readable medium for enabling communication in the federated computing environment.

### DETAILED DESCRIPTION

The present subject matter relates to techniques of communicating in a federated computing environment. The techniques described herein can be implemented in a variety of computing devices, such as a server, a desktop computer, a notebook or a portable computer, a mainframe computer, a mobile computing device, and the like, that form a part of a pool of computing resources of the federated computing environment.

Generally, different computing resources from the pool of computing resources of the federated computing environment are utilized by users for varied purposes. While utilizing separate computing, a user has to be authenticated by each of the computing resource the user wishes to access. In other words, credentials of the user are to be authenticated by every computing resource of the federated computing environment whose capabilities are to be utilized. To avoid multiple authentication processes at each and every computing resource, generally single-point authentication is employed by the federated computing environments. A single-point authentication mechanism utilizes a dedicated authenticating computing resource, which allocates a token to a requesting user for accessing all the computing resources within the pool of computing resources. However, implementation of such dedicated authenticating computing resource limits the access to individual computing resources while the dedicated authenticating computing resource is unavailable. Further, implementation of a single dedicated authenticating computing resource creates a single point of failure. Moreover, in situations where multiple users are requesting for access and tokens, dependency on the single dedicated authenticating computing resource creates delays, thereby causing performance issues.

Certain implementations of the federated computing environment utilize global authentication technique where any of the computing resource from amongst the pool of computing resources may issue token of authentication for accessing any of the computing resource. However, such techniques of global authentication utilize dynamic token generation which impacts performance in highly resilient and high performance critical federated computing environments.

According to an implementation of the present subject matter, techniques of communication in a federated computing environment are described. The federated computing environment may include a pool of computing resources where each computing resource may be accessed by one or more different users to utilize the processing capabilities of the computing resource. It would be noted that each computing resource within the pool of computing resources may either include similar processing capabilities, or may include different processing capabilities, depending upon the implementation of the federated computing environment. Further, the federated computing environment may either be a homogenous environment where each of the computing resource communicates based on similar data presentations and protocol of communication, or may be a heterogeneous computing environment where different computing resources implement different data presentations and protocols of communication.

The pool of computing resources may be distributed over the communication network and may be communicatively coupled with each other. As used herein, ‘communicatively coupled’ may mean a direct connection between entities in consideration to exchange data signals with each other via an electrical signal, electromagnetic signal, optical signal, etc. For example, entities that may either be directly communicatively connected with and/or collocated in/on a same device (e.g., a computer, a server, etc.) and communicatively connected to one another have been referred to be communicatively coupled with each other, hereinafter. Therefore, the computing resources of the federated computing environment communication through a direct communication have been referred to be ‘communicatively coupled’ to each other.

Further, it would be noted that users utilizing the processing capabilities of computing resources within the pool of computing resources would utilize user devices for communicating with the computing resources. As used herein, ‘communicating with’ may mean either a communication via a network or an indirect communication link (e.g., a communication link including an intermediate communication device, such as a router, another entity, and the like.) between entities in consideration. For example, entities that may be either communicating via a network, or through an indirect communication link have been referred to be communicating with each other, hereinafter. Therefore, user devices communicating via a network or through an indirect communication link with the computing resources of the federated computing environment have been refereed to be ‘communicating with’ the computing resources.

In an example implementation of the present subject matter, global tokens may be generated among the pool of computing resources and allocated to users for accessing any of the computing resources within the federated computing environment. Such global tokens may be allocated by any of the computing resource within the pool of computing resources and may then be authenticated by any other computing resource, prior to granting resource access to the user.

In operation, each of the computing resource may identify other computing resources present in the federated computing environment. Upon identification of such other computing resources within the federated computing environment, each computing resource may exchange their trust parameters with the other computing resources. The exchange of the trust parameters may be done to establish trust and uniquely identify all the other computing resources within the federated computing environment.

In an implementation of the present subject matter, each computing resource of the federated computing environment may be associated with a unique Identification (UID) to uniquely distinguish the computing resource from other computing resources of the federated computing environment. Accordingly, in an example implementation of the present subject matter, the trust parameters, apart from other information, may include the unique UID corresponding to each of the computing resource. Therefore, it would be noted that upon exchange of the trust parameters among all the computing resources, each computing resource within the pool of computing resources may be aware of the UID of all the other computing resources with the pool of computing resources. In another example, the trust parameters may also include a public key of encryption corresponding to private key of encryption utilized by each of the computing resource.

Further, in an example, each computing resource may also generate a set of tokens which can be allocated to users for accessing processing capabilities of computing resources within the pool of computing resources, and can be authenticated by any computing resource within the pool of computing resources. All the computing resources may communicate such set of generated tokens with other computing resources to create a pool of tokens. For the sake of explanation, the set of tokens generated by each computing resource are referred to as first set of tokens for that respective computing resource. Further, all the other tokens that are received by such computing resource from other computing resources have been referred to as second set of tokens for that respective computing resource. Furthermore, the entire set of tokens available with each computing resource, including the first set of tokens and the second set of tokens have been referred to as global set of tokens, hereinafter.

Therefore, upon exchange of first set of tokens and receiving the second set of tokens, each computing resource within the pool of computing resources have its own list of global set of tokens. The token within the global set of tokens may then be utilized by each of the computing resources for the purpose of allocation to users.

In an example implementation of the present subject matter, a user, requesting access to any of the computing resource within the federated computing environment is allocated a token, from the global set of tokens. Such token may be allocated by any of the computing resources within the federated computing environment. Accordingly, the implementation of the present subject matter does not necessitate use of a central computing resource for the purpose of token allocation, thereby eliminating any single point of failure and processing delays. Furthermore, since the global set of tokens are available with each of the computing resources, independent authentication can be carried out by each of the computing resource, and separate communication overhead for authentication of such tokens may also be eliminated.

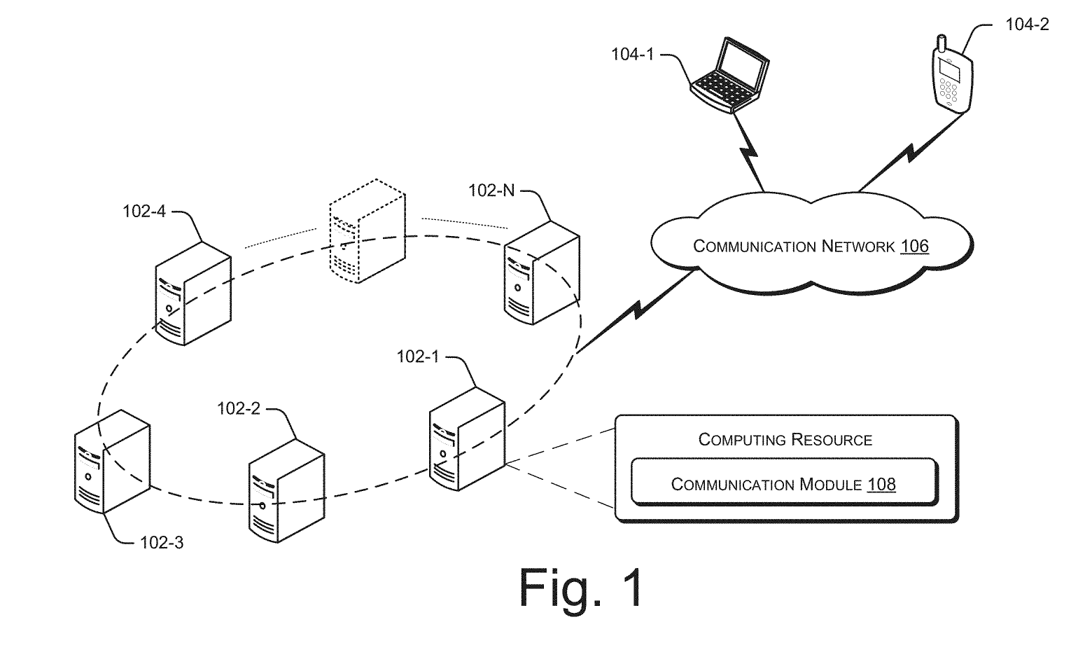

The above techniques are further described with reference to FIG. 1 to FIG. 6. It should be noted that the description and the figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 schematically illustrates a federated computing environment 100, implementing a pool of computing resources, according to an example implementation of the present subject matter. The federated computing environment 100 may either be a public distributed environment, or may be a private distributed environment. The pool of computing resources may include multiple computing resources 102-1, 102-2, 102-3, 102-4, . . . , 102-N. For the sake of explanation, the computing resources 102-1, 102-2, 102-3, 102-4, . . . , 102-N have been commonly referred to as the pool of computing resources 102, and have been individually referred to as computing resource 102.

The pool of computing resources 102 may communicate with one or more user devices, such as user device 104-1 and user device 104-2, through a communication network 106. For the sake of explanation, the user devices 104-1, and 104-2 have been commonly referred to as user devices 104, and have been individually referred to as user device 104.

According to an example implementation of the present subject matter, each computing resource 102 within the pool of computing resources 102 may be implemented as, but is not limited to, a server, a workstation, a desktop computer, a laptop, a smart phone, a personal digital assistant (PDAs), tablet, a virtual host, an application, and the like. Further, each computing resource 102 may also be a machine readable instructions-based implementation or a hardware-based implementation or a combination thereof.

Similarly, each user device may be implemented as, but is not limited to, a server, a workstation, a desktop computer, a laptop, a smart phone, a personal digital assistant (PDAs), a tablet, a virtual host, an application, and the like. Any communication link, as depicted between the pool of computing resources 102 and the communication network 106, or the user devices 104 and the communication network 106, may be enabled through a desired form of communication, for example, via dial-up modem connections, cable links, digital subscriber lines (DSL), wireless or satellite links, or any other suitable form of communication.

Further, the communication network 106 may be a wireless network, a wired network, or a combination thereof. The communication network 106 may also be an individual network or a collection of many such individual networks, interconnected with each other and functioning as a single large network, e.g., the Internet or an intranet. The communication network 106 may be implemented as one of the different types of networks, such as intranet, local area network (LAN), wide area network (WAN), and such. The communication network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other.

The communication network 106 may also include individual networks, such as, but are not limited to, Global System for Communication (GSM) network, Universal Telecommunications System (UMTS) network, Long Term Evolution (LTE) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the implementation, the communication network 106 may include various network entities, such as base stations, gateways and routers; however, such details have been omitted to maintain the brevity of the description. Further, it may be understood that the pool of computing resources 102, the user devices 104, and other entities may take place based on the communication protocol compatible with the communication network 106.

For the purpose of explanation, users utilizing the user devices 104 have been described to interact with the pool of computing resources 102. It would be noted that any user, interacting with a computing resource 102 of the pool of computing resources 102, would interact thorough a computing devices, such the user devices 104.

In an example implementation of the present subject matter, each computing resource 102 may include a communication module 108. The communication module 108 may facilitate communication of the corresponding computing resource 102, with other computing resources within the pool of computing resources 102. Further, the communication module 108 may also facilitate communication of the corresponding computing resource 102 with the communication network 106, through one or more communication links.

In operation, the communication module 108 may communicate trust parameters with each of the other computing resources within the pool of computing resources 102. In an example implementation of the present subject matter, the trust parameters, apart from other information, may include unique identification (UID) corresponding to each computing resource 102. The communication of the trust parameters may allow each computing resource 102 to authenticate other computing resource 102, while also gather UID, associated with other computing resources within the pool of computing resources 102.

For example, the pool of computing resources 102 may include 10 different computing resources. Each computing resource 102 may have a UID associated with itself. It would be noted that the UID may either be randomly generated by each of the computing resource 102, or may be allocated by a network entity at the time of bootstrapping, like allocation of a dynamic Internet Protocol (IP) Address. Thereafter, the communication module 108 of each of the 10 computing resources may communicate their respective trust parameters to other computing resources within the pool of computing resources 102.

The communication module 108 of each of the computing resources 102 may receive the trust parameters corresponding to all other computing resources within the pool of computing resources 102 and may establish trust based on the exchanged information within the trust parameters. In an example, the trust parameter, apart from the UID of corresponding computing resource 102, may include information, such as federated computing environment resource ID (FCERID), authentication certificate, processing capability details, and public key of encryption corresponding to a utilized private encryption key. Therefore, based on exchange of the trust parameters among the computing resources, each computing resource 102 within the pool of computing resources 102 can be identified and authenticated by other computing resources.

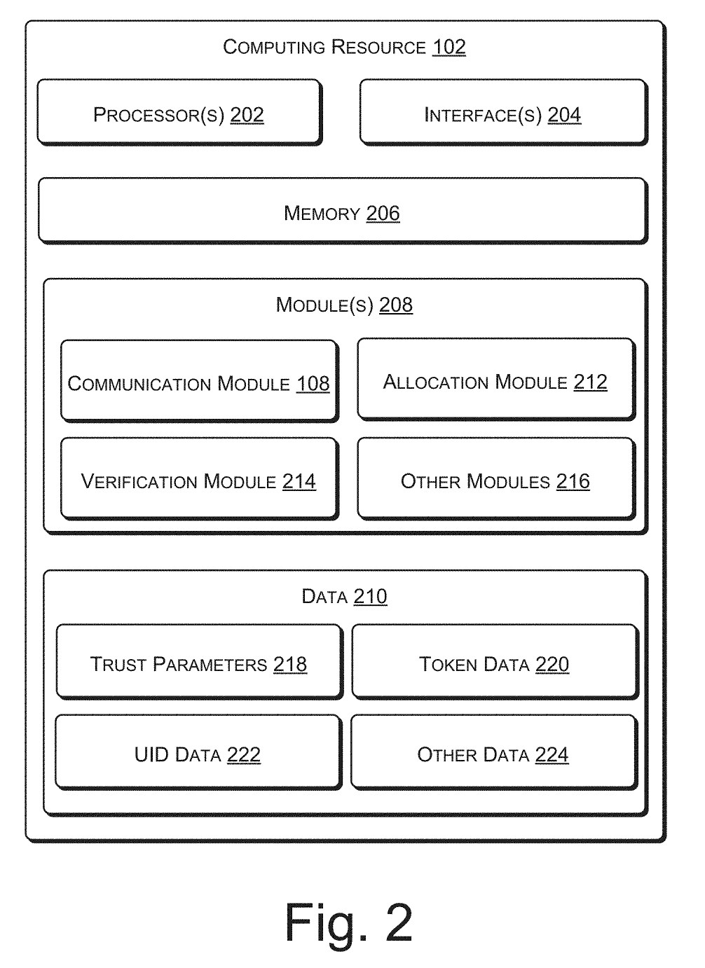

In an example implementation of the present subject matter, each computing resource 102 may then generate a first set of tokens and share the first set of tokens with other computing resources within the pool of computing resources 102, through the communication module 108. The exchange of the first set of tokens corresponding to each of the computing resource 102 may create a global set of tokens with each of the computing resource 102, where each token within the global set of tokens can be authenticated by any of the computing resources within the pool of computing resources 102. Such example functionalities and example components have been further described in more detail in reference to FIG. 2.

FIG. 2 schematically illustrates components of a computing resource 102, according to an example implementation of the present subject matter. The computing resource 102 may also include processor(s) 202 and interface(s) 204. The processor(s) 202 may be implemented as microprocessor(s), microcomputer(s), microcontroller(s), digital signal processor(s), central processing unit(s), state machine(s), logic circuit(s), and/or any device(s) that manipulates signals based on operational instructions. Among other capabilities, the processor(s) 202 may fetch and execute computer-readable instructions stored in a memory. The functions of the various elements shown in the figure, including any functional blocks labeled as “processor(s)”, may be provided through the use of dedicated hardware as well as hardware capable of executing machine readable instructions.

The interface(s) 204 may include a variety of machine readable instructions-based interfaces and hardware interfaces that allow the computing resource 102 to interact with different other computing resources and user devices 104. Further, the interface(s) 204 may enable the computing resource 102 to communicate with other communication and computing devices, such as network entities, web servers, and external repositories.

Further, the computing resource 102 may include a memory 206, communicatively coupled to the processor(s) 202. The memory 206 may include any computer-readable medium including, for example, volatile memory (e.g., RAM), and/or non-volatile memory (e.g., EPROM, flash memory, Memristor, etc.). Further, the computing resource 102 may include module(s) 208 and data 210. The module(s) 208 may be communicatively coupled to the processor(s) 202. The module(s) 208, amongst other things, include routines, programs, objects, components, data structures, and the like, which perform particular tasks or implement particular abstract data types. The module(s) 208 further include modules that supplement applications on the computing resource 102, for example, modules of an operating system. The data 210 serves, amongst other things, as a repository for storing data that may be fetched, processed, received, or generated by the module(s) 208. Although the data 210 is shown internal to the computing resource 102, it may be understood that the data 210 may reside in an external repository (not shown in the figure), which may be communicatively coupled to the computing resource 102. The computing resource 102 may communicate with the external repository through the interface(s) 204 to obtain information from the data 210.

In an implementation, the module(s) 208 of the computing resource 102 may include the communication module 108, an allocation module 212, a verification module 214, and other module(s) 216. In an implementation, the data 210 of the computing resource 102 may include trust parameters 218, token data 220, UID data 222, and other data 224. The other module(s) 216 may include programs or coded instructions that supplement applications and functions, for example, programs in the operating system of the computing resource 102, and the other data 224 fetched, processed, received, or generated by the other module(s) 216.

The following description describes the computing resource 102 communicating with one or more users in the federated computing environment 100. The users may utilize one or more user devices 104 for the purpose of communication. Each user may utilize one or more computing resources from the pool of computing resources 102 to perform one or more tasks. Accordingly, the computing resources within the pool of computing resources 102 may provide different processing capability and may include different hardware configurations to support such processing capabilities.

In an example implementation of the present subject matter, upon exchanging the trust parameters with other computing resources, the computing resource 102 may generate a first set of tokens, where a token within the first set of tokens may be used for allocation to users for accessing the processing capabilities of the pool of computing resources 102. Each token can be understood as either a string of information, or a certificate, which may be used by the user to obtain access to processing capabilities of the computing resources within the pool of computing resources 102. In an example, each token may include the UID of the generating computing resource 102 and a unique string of data to indicate the generating entity of the corresponding token.

For example, if the computing resource 102-2 generates a first set of tokens, all tokens within the first set of tokens may include the UID corresponding to the computing resource 102-2. Further, each such token may also include the unique string of data which may distinguish one token from another. The unique string of data may include information, such as a random string and a time stamp of generation. Therefore, it would be noted that all tokens within the first set of tokens generated by the computing resource 102-2 may include the same UID, however would include a unique string of data to distinguish one token from another token.

Accordingly, it would further be noted that each token generated by any of the computing resource 102 could be uniquely identified based on the UID and the unique string of data included therein.

In an example implementation of the present subject matter, the communication module 108 of the computing resource 102 may communicate first set of tokens to other computing resources. Similarly, the communication module 108 may receive first set of tokens corresponding to other computing resources as well. Accordingly, for each computing resource 102, the tokens received from other computing resources are referred to as second set of tokens. In an example implementation, the first set of tokens and the second set of tokens may be stored in the token data 220.

As explained earlier, for the sake of explanation, the compete set of tokens, including the first set of tokens and the second set of tokens have been referred to as the global set of tokens. Therefore, the communication module 108 can be understood to populate global set of tokens usable for accessing the pool of computing resources 102. Each token within the global set of tokens may be allocated to a user for accessing the processing capabilities of computing resources within the pool of computing resources 102. In an example implementation of the present subject matter, a user in possession of a token corresponding to the global set of tokens may be validated by any computing resource 102 within the pool of computing resources 102.

The process of allocation of tokens to users, and their independent validation by any of the computing resource 102 within the pool of computing resources 102 has been further described with the help of the foregoing description.

In an example implementation of the present subject matter, any computing resource 102 may receive a connection request from a user. For example, the computing resource 102-1 may receive the connection request from a user. The connection request may either be received to access the processing capability of the computing resource 102-1, or may be received to access any other computing resource 102 within the pool of computing resources 102. In either case, the computing resource 102-1 may first allocate a token to the user. Allocation of a token to the user may allow the user to utilize processing capability of any computing resource 102 within the pool of computing resources 102, including the computing resource 102-1.

Prior to allocation of a token to the user, the allocation module 212 of the computing resource 102-1 may validate the user based on user information included within the connection request. That is, user may be authenticated to determine if a token can be allocated to the user for accessing the computing resources within the pool of computing resources 102. In one example implementation, the user may be authenticated by comparing the user information received within the connection request against predefined user credentials. The predefined user credentials may be accessible to the allocation module 212. In an example implementation, the predefined user credentials may be stored in the data 210 and the allocation module 212 may directly access the predefined user credentials from the data 210. In another example implementation, the predefined user credentials may be stored in an external storage unit, such as a user directory (not shown) and the allocation module 212 may access the stored predefined user credentials through such external storage unit.

The user information based on which the user may be validated may vary between implementations of the federated computing environment 100. Federated computing environments 100 implemented with medium level security may validate users based on a user id. and a unique password associated with the user id. More secure implementations of the federated computing environment 100 may validate users through a one time password which the user may provide along with the connection request. Similarly, in low level security implementations of the federated computing environment 100, the user may merely be validated to be a human by receiving a Completely Automated Public Turing test to tell Computers and Humans Apart (CAPTCHA) response along with the connection request. Accordingly, the allocation module 212 of the computing resource 102 may validate users based on a validation mechanism.

Upon validating the user corresponding to the connection request, the allocation module 212 may allocate a token to the user. In an example implementation of the present subject matter, the allocation module 212 may either allocate a token from the first set of tokens, or may allocate the token from the global set of tokens.

It would be noted that the tokens within the first set of tokens are generated by the computing resource 102, itself, while the global set of tokens includes tokens generated by all the computing resources within the pool of computing resources 102. Accordingly, in an example, if the allocation module 212 of the computing resource 102-1 allocates a token from a first set of tokens, the token would have been generated by the computing resource 102-1. However, if the allocation module 212 of the computing resource 102-1 allocates a token from the global set of tokens, the token could have been either generated by the computing resource 102-1, or could have been generated by any other computing resource 102 within the pool of computing resources 102. In an example implementation of the present subject matter, based on the implementation of the federated computing environment 100, the allocation module 212 may determine to either allocate the token to a user from the first set of tokens, or from the global set of tokens.

In situations where the allocation module 212 may allocate tokens from the global set of tokens, to eliminate any duplicate allocation by any other computing resource 102, the communication module 108 may broadcast the allocated token details to all the other computing resources within the pool of computing resources 102. Such broadcast of the allocated token details may allow the computing resources to determine allocated tokens from the global set of tokens, thereby eliminating duplicate allocation.

Although in different implementations of different federated computing environment 100, the allocation module 212 may allocate token either from the first set of tokens, or from the global set of tokens, for the sake of explanation of the present subject matter, it has been considered that the allocation module 212 allocates tokens to users from the first set of tokens.

In an example implementation of the present subject matter, prior to allocation of a determined token to a user, the allocation module 212 may also include validation information with the token. The validation information may, at least include access privileges corresponding to the user. For example, if a user ‘A’ sends a connection request to the computing resource 102-1, and the allocation module 212 of the computing resource 102-1 determines a token to be allocated from the first set of tokens of the computing resource 102-1, the allocation module 212 may also determine access privileges to be provided to the user and include such access privileges with in the token.

Further, the allocation module 212 may also encrypt the token with a private encryption key and append the UID of the computing resource 102-1 to the encrypted token. The final encrypted token along with the appended UID may be then be allocated by the allocation module 212 to the user. In an example implementation of the present subject matter, the user may utilize the token to access processing capabilities of any of the computing resources within the pool of computing resources 102 by providing the allocated token for verification.

The user may send an access request to any of the computing resource 102 within the pool of computing resources 102 to access processing capabilities of the computing resource 102. In the access request, the user may provide the allocated token to any of the computing resource 102 for verification and obtain access to the processing capabilities of such computing resource 102. In an example implementation of the present subject matter, the verification module 214 of the computing resource 102 may verify the received token from a user and may grant access of the processing capabilities upon verification of such token.

In an example, to verify the received token, the verification module 214 may first determine the computing resource 102 to have allocated the token to the user. It would be noted that the token received by the verification module 214 may be encrypted and may also include an appended UID of an issuing computing resource 102. Therefore, the verification module 214 may determine the allocating computing resource 102 of the received token based on the appended UID. In one example implementation, based on the identification of the allocating computing resource 102, the verification module 214 may also determine a corresponding public key to be utilized to decrypt the encrypted token. As described earlier, public key of encryption, corresponding to each computing resource 102, may be available with all the computing resources within the pool of computing resources 102 after exchange of the trust parameters.

Hence, the verification module 214, based on a public key of encryption corresponding to the issuing computing resource 102, may decrypt the received token. The decrypted token may include, apart from other information, UID of the computing resource 102 that had originally generated the token.

It would be noted that the computing resource 102 to allocate the token to the user may be same as that of the computing resource 102 to have generated the token initially, since the token may have been allocated from the first set of tokens corresponding to the computing resource 102. For example, the computing resource 102-1 may generate a first set of tokens and may allocate a token to a user from such first set of tokens, upon receiving a connection request. In such situation, the computing resource 102-1 would be the computing resource 102 to have generated the token, as well as the computing resource 102 to have allocated the token.

In an example implementation of the present subject matter, the verification module 214 may compare the UID of the computing resource 102 to have allocated the token with the UID of the computing resource 102 to have generated the token, to authenticate the user. In another example of the present subject matter, the verification module 214 may merely compare the UID received after decrypting the token, i.e., the UID corresponding to the computing resource 102 to have generated the token, with the UID data 222 to validate its authenticity.

The verification module 214 may also implement access rights on user. In an example implementation of the present subject matter, the decrypted token may include access rights applicable for the user, and may have earlier been decided at the time of allocation of the token. Therefore, the verification module 214, based on the identified access rights, may enforce appropriate restrictions and grants on the accessing privileges of the user of the computing resource 102.

Accordingly, a user may be independently authenticated by any of the computing resource 102 within the pool of computing resources 102, without having for the computing resource 102 to communicate with either another computing resource 102 of the federated computing environment 100, or any third party.

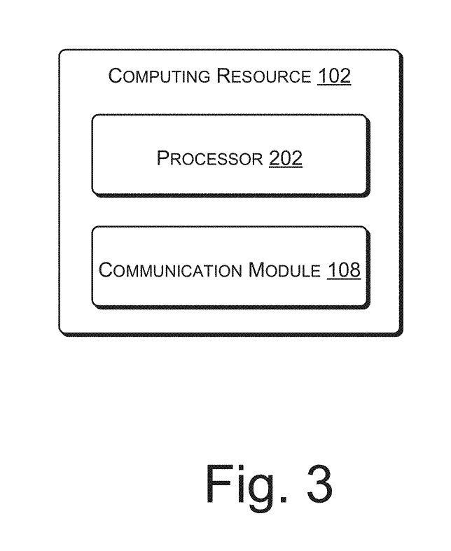

FIG. 3 represents an example computing resource 102 within the federated computing environment 100. The computing resource 102 may include the processor 202 and the communication module 108. The communication module 108 may allow the computing resource 102 to communicate with other computing resources of the federated computing environment 100. As described earlier, the communication module 108 of the computing resource 102 may exchange trust parameters with other computing resources to authenticate all the computing resources and establish trust with all the computing resources. In an example implementation of the present subject matter, the communication module 108 may also exchange the first set of tokens corresponding to the computing resource 102 with other computing resources to generate a global set of tokens.

The computing resource 102 may also receive connection requests from users and may allocate tokens to each of such connection requests based on the above described techniques. Further, the computing resource 102 may also validate tokens of users to allow access to the users of its processing capabilities based on the above described techniques and the details of such described techniques have been avoided here for the sake of brevity.

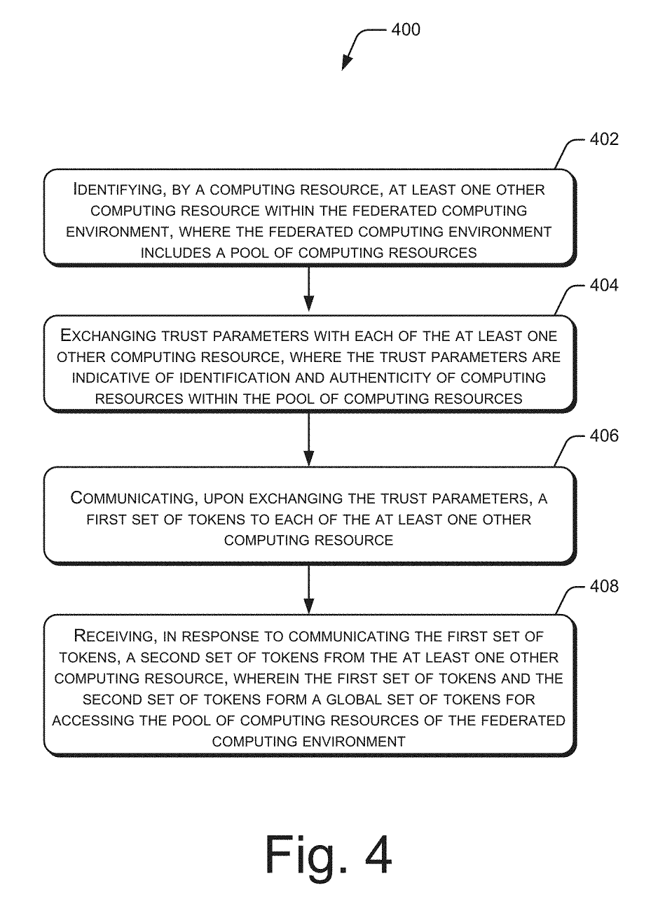

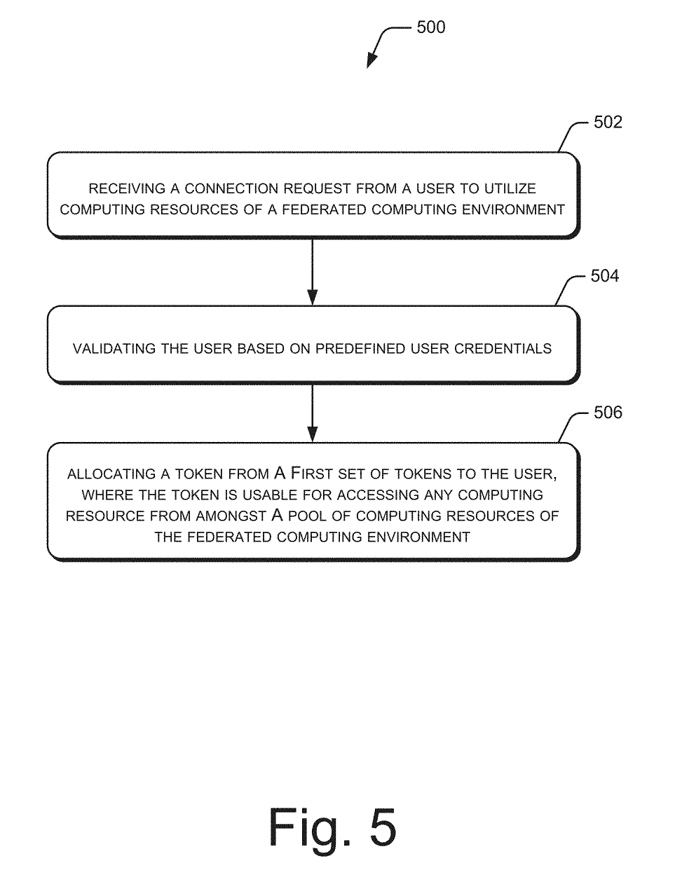

FIG. 4 and FIG. 5 illustrates methods 400 and 500 for communication in a federated computing environment, according to an implementation of the present subject matter. The order in which the methods 400 and 500 are described is not intended to be construed as a limitation, and any number of the described method blocks may be combined in any order to implement the methods 400 and 500, or an alternative methods. Furthermore, the methods 400 and 500 may be implemented by processor(s) or computing device(s) through any suitable hardware, non-transitory machine readable instructions, or combination thereof.

It may be understood that steps of the methods 400 and 500 may be performed by programmed computing devices. The steps of the methods 400 and 500 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media.

Further, although the methods 400 and 500 may be implemented in a variety of computing resource of federated computing environment; in an example implementation of FIG. 4 and FIG. 5, the methods 400 and 500 may be explained in context of aforementioned computing resource 102-1 of the federated computing environment 100, for ease of explanation.

Referring to FIG. 4, in an example implementation of the present subject matter, at block 402, at least one other computing resource within the federated computing environment may be identified, where the federated computing environment includes a pool of computing resources. For example, the computing resource 102-1 may identify other computing resources within the pool of computing resources.

At block 404, trust parameters are exchanged between each of the at least one other computing resource. In an example implementation of the present subject matter, the trust parameters may indicate identification and authenticity of computing resources within the pool of computing resources. For example, the computing resource 102-1 of the federated computing environment 100 may include an UID associated with itself along with other information, such as a public key of encryption corresponding to private key of encryption utilized by computing resource 102-1 in the trust parameters.

At block 406, a first set of tokens may be communicated to each of the at least one other computing resource. For example, the computing resource 102-1 may generate the first set of tokens and may communicate them to all the computing resources within the pool of computing resources of the federated computing environment 100.

At block 408, a second set of tokens may be received from the at least one other computing resource, wherein the first set of tokens and the second set of tokens form a global set of tokens for accessing the pool of computing resources of the federated computing environment 100.

Referring to FIG. 5, in an example implementation of the present subject matter, at block 502, a connection request may be received from a user to utilize computing resources of a federated computing environment 100. In an example, the computing resource 102-1 may receive the connection request from a user ‘A’.

At block 504, the user may be validated based on predefined user credentials. In an example implementation of the present subject matter, the computing resource 102-1 may validate the user based on user id. and password included within the connection request.

At block 506, a token may be allocated from a first set of tokens, to the user. The token may be used by the user for accessing any computing resource 102 from amongst a pool of computing resources of the federated computing environment 100.

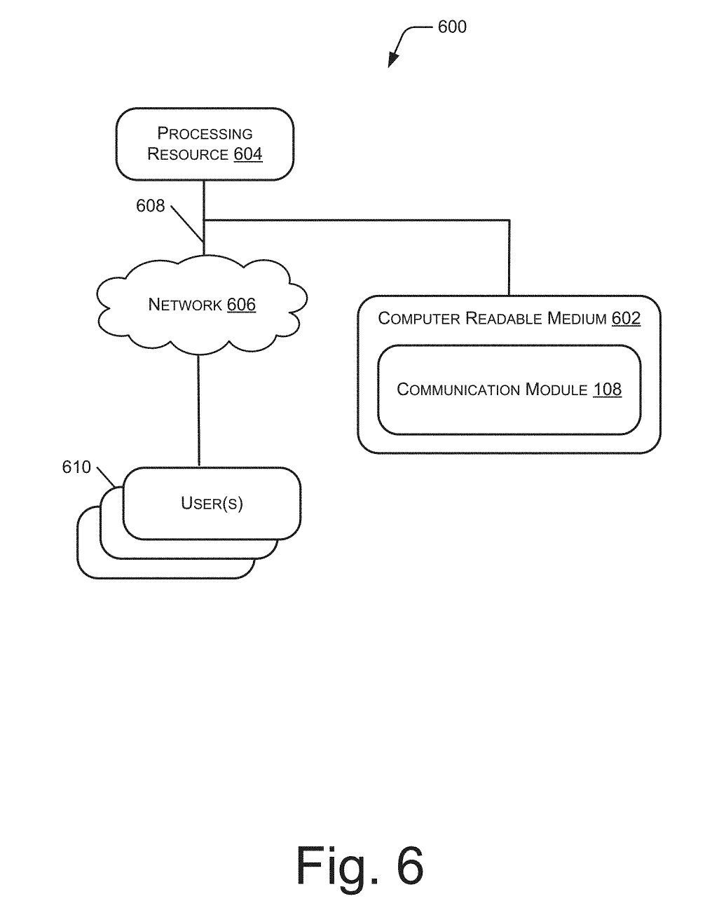

FIG. 6 illustrates a federated computing environment 600 implementing a non-transitory computer-readable medium 602, according to an implementation of the present subject matter. In one implementation, the non-transitory computer readable medium 602 may be utilized by a computing resource, such as the computing resource 102 (not shown). The computing resource 102 may be a part of the federated computing environment 600 and be implemented in a public networking environment or a private networking environment. In one implementation, the federated computing environment 600 includes a processing resource 604 communicatively coupled to the non-transitory computer readable medium 602 via a communication network 606, through a communication link 608.

For example, the processing resource 604 may be implemented in a computing resource, such as the computing resource 102 described earlier. The computer readable medium 602 may be, for example, an internal memory device or an external memory device. In one implementation, the communication link 608 may be a direct communication link, such as any memory read/write interface. In another implementation, the communication link 608 may be an indirect communication link, such as a network interface. In such a case, the processing resource 604 may access the computer readable medium 602 through the communication network 606. The communication network 606 may be a single network or a combination of multiple networks and may use a variety of different communication protocols.

The processing resource 604 and the computer readable medium 602 may also be communicating with users 610 over the communication network 606. The users 610 may utilize user devices, such as desktop computers, laptops, smart phones, PDAs, and tablets to communicate with the computer readable medium 602 and the processing resource 604. The user devices may include applications that communicate with the processing resource 604 and the computer readable medium 602, in accordance with an example of the present subject matter.

In one implementation, the computer readable medium 602 includes a set of computer readable instructions, such as the communication module 108. The set of computer readable instructions may be accessed by the processing resource 604 through the communication link 608 and subsequently executed to process data communicated with the users 610.

In an example implementation of the present subject matter, the communication module 108 of the computer readable medium 602 may exchange trust parameters with other computing resource of the federated computing environment 600. The communication module 108 may also exchange the first set of tokens with other computing resources to generate a global set of tokens. The computer readable medium 602 may also receive connection requests from users and may allocate tokens to each of such connection requests.

In another example, the computer readable medium 602 may also validate tokens of users to allow access to the users of the processing resource 604.

Although implementations of communication in a federated computing environment have been described in language specific to structural features and/or methods, it is to be understood that the present subject matter is not necessarily limited to the specific features or methods described. Rather, the specific features and methods are disclosed and explained in the context of a few implementations for communication in federated computing environments.

What is claimed is:

1. A method for communication in a federated computing environment, the method comprising:
identifying, by a computing resource, at least one other computing resource within the federated computing environment, wherein the federated computing environment includes a pool of computing resources;
exchanging trust parameters with each of the at least one other computing resource, wherein the trust parameters are indicative of identification and authenticity of computing resources within the pool of computing resources;
communicating, upon exchanging the trust parameters, a first set of tokens to each of the at least one other computing resource; and
receiving, in response to communicating the first set of tokens, a second set of tokens from each of the at least one other computing resource, wherein the first set of tokens and the second set of tokens form a global set of tokens for accessing the pool of computing resources of the federated computing environment.

2. The method as claimed in claim 1, wherein the method further comprises:
receiving, by the computing resource, a connection request from a user to utilize processing capabilities of computing resources of the federated computing environment;
validating the user based on predefined user credentials; and
allocating a token from the first set of tokens to the validated user, wherein the token is usable for accessing any computing resource from amongst the pool of computing resources of the federated computing environment.

3. The method as claimed in claim 2, wherein the allocating comprises:
selecting the token from the first set of tokens;
identifying access privileges corresponding to the user;
including validation information with the token, wherein the validation information includes at least the access privileges; and
encrypting the token along with the validation information for allocation to the user.

4. The method as claimed in claim 1, wherein each token within the global set of tokens includes at least a unique identification (UID) corresponding to one of the computing resources within the pool of computing resources, and a unique string of data.

5. The method as claimed in claim 1, wherein the trust parameters corresponding to each of the computing resources within the pool of computing resources of the federated computing environment include at least a corresponding unique identification (UID) and a corresponding public key of encryption.

6. The method as claimed in claim 1, wherein the method further comprises:
receiving, by the computing resource, an access request from a user for utilizing processing capabilities of the computing resource, wherein the access request includes a token for accessing the computing resource, and wherein the token is allocated to the user by one of the at least one other computing resource;
decrypting the token based on public key of encryption of the one of the at least one other computing resource to determine a unique identification (UID) included within the token; and
comparing the determined unique UID with a unique UID of the one of the at least one other computing resource to validate the token.

7. The method as claimed in claim 6, wherein the method further comprises:
identifying access rights included in the token, applicable to the user;
enforcing the access rights on the user for utilizing the processing capabilities of the computing resource.

8. A computing resource of a federated computing environment, the computing resource comprising:
a processor;
a communication module communicatively coupled with the processor to:
exchange trust parameters with each computing resource within a pool of computing resources of the federated computing environment, wherein the trust parameters are indicative of identification and authenticity of computing resources within the pool of computing resources; and
populate a global set of tokens usable for accessing the pool of computing resources of the federated computing environment, wherein to populate the global set of tokens, the communication module is to:
share a first set of tokens with each of the computing resource within the pool of resources; and
receive a second set of tokens from each of the computing resource.

9. The computing resource as claimed in claim 8, wherein the communication module is further to receive a connection request from a user to utilize the computing resources, and wherein the computing recourse further comprises an allocation module to:
validate the user based on predefined user credentials; and
allocate a token from the global set of tokens to the user, wherein the token is usable for accessing any computing resource from amongst the pool of computing resources of the federated computing environment.

10. The computing system as claimed in claim 9, wherein the communication module is further to intimate the allocation of the token to each of the computing resource within the pool of computing resources.

11. The computing resource as claimed in claim 9, wherein the allocation module is further to:
select the token from the global set of tokens;
identify access privileges corresponding to the user;
append validation information to the token, wherein the validation information includes at least the access privileges; and
encrypt the token along with the validation information for allocation to the user,
to allocate the token from the global set of tokens.

12. The computing system as claimed in claim 8, wherein the communication module is to further receive an intimation of allocation of a token from the global list of tokens, and wherein computing resource further comprises an allocation module to remove the token from the global list of tokens maintained by the computing resource.

13. The computing resource as claimed in claim 8, wherein the communication module is further to receive an access request from a user for utilizing processing capabilities of the computing resource, wherein the access request includes a token for accessing the computing resource, and
the computing resource further comprises a verification module to:
decrypt the token to determine a unique identification (UID) included within the token; and
validate the token by comparing the determined unique UID with a list of unique Ids. received during the exchange of the trust parameters.

14. A non-transitory computer-readable medium comprising instructions for a computing resource, executable by a processing resource to:
identify at least one other computing resource within the federated computing environment, wherein the federated computing environment includes a pool of computing resources;
exchange trust parameters with each of the at least one other computing resource, wherein the trust parameters are indicative of identification and authenticity of computing resources within the pool of computing resources;
communicate, upon exchanging the trust parameters, a first set of tokens to each of the at least one other computing resource; and
receive, in response to communicating the first set of tokens, a second set of tokens from the at least one other computing resource, wherein the first set of tokens and the second set of tokens form a global set of tokens for accessing the pool of computing resources of the federated computing environment.

15. The non-transitory computer-readable medium as claimed in claim 14 further comprising instructions executable to:
receive a connection request from a user to utilize computing resources of the federated computing environment;
validate the user based on predefined user credentials; and
allocate a token from the first set of tokens to the user, wherein the token is usable for accessing any computing resource from amongst the pool of computing resources of the federated computing environment.
